(19) United States
(12) Patent Application Publication
(10) Pub. No.: US 2026/0293948 A1
(43) Pub. Date: Oct. 1, 2026

(54) System and method for producing a condensed panela sweetener with versatile culinary and beverage applications

(71) Applicant: Fernando Bohorquez Nieto, Queens, NY (US)

(72) Inventor: Fernando Bohorquez Nieto, Queens, NY (US)

(21) Appl. No.: 18/831,523

(22) Filed: Mar. 27, 2025

(51) Int. Cl. A23L 27/10; A23L 2/54; A23L 2/60; A23L 21/10

(52) U.S. Cl. CPC A23L 27/10; A23L 2/54; A23L 2/60; A23L 21/10

(57) ABSTRACT

A system and method for producing a condensed panela-based natural sweetener are disclosed. The invention involves breaking a solid panela block, mixing it with water and optional natural flavor enhancers, and heating the mixture until uniform syrup forms. The resulting syrup serves as a versatile natural sweetener for culinary applications and beverages. It can be directly used for drizzling over desserts, spreading on toast, or enhancing recipes, and it can also be diluted with water or carbonated with CO₂ to create naturally flavored sodas. The process maintains the nutritional benefits of panela while providing improved convenience and uniform sweetness. Additionally, microfiltration ensures a smooth texture before packaging. This invention modernizes the traditional use of panela while maintaining its natural integrity and cultural relevance.

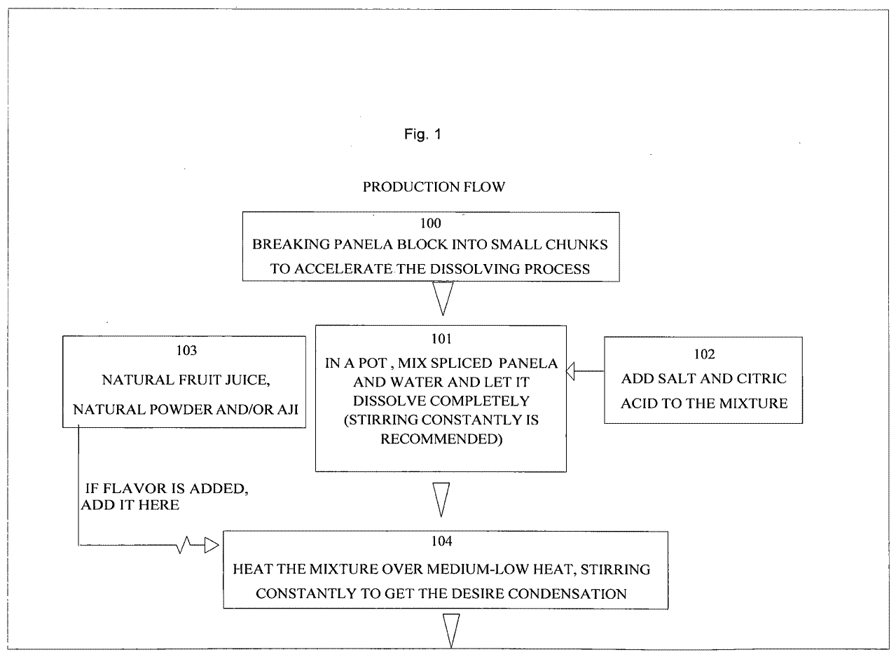

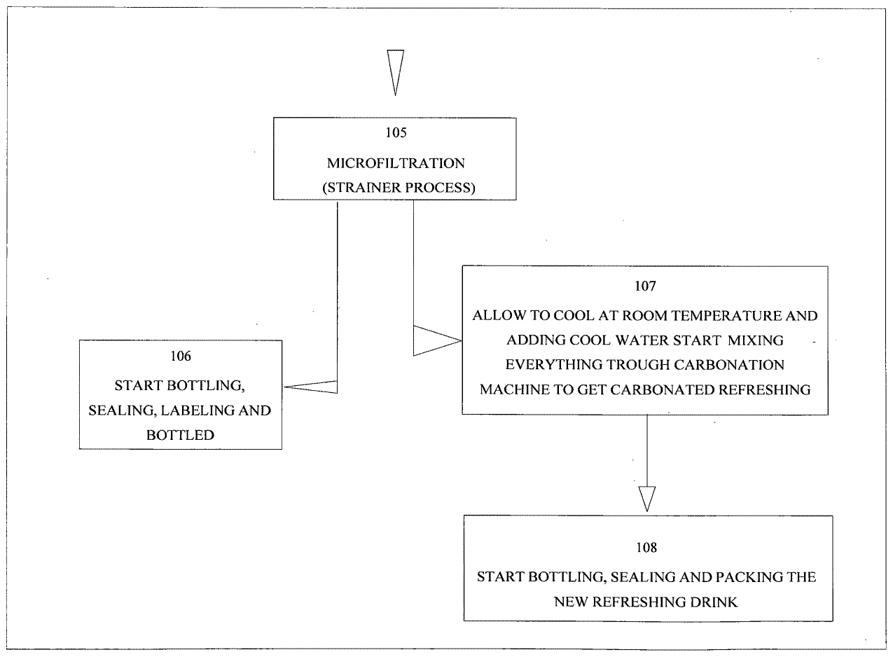

### CROSS REFERENCE TO RELATED APPLICATIONS

“This application claims priority to U.S. Provisional Patent Application No. 63/675,795, filed on Jul. 26, 2024, entitled ‘[Previous Provisional Title],’ the contents of which are incorporated herein by reference in their entirety.

This application expands upon the methodologies disclosed in the provisional filing by introducing enhanced microfiltration, extended shelf-life stabilization, and optimized carbonation integration for commercial beverage applications. The present invention also refines industrial scalability, supporting streamlined high-volume production and packaging efficiency.

### BACKGROUND OF THE INVENTION

### Technical Field

The present invention relates to food processing technology, specifically to methods for transforming solid panela into a versatile condensed sweetener for culinary and beverage applications.

### Challenges in Traditional Panela Use

Panela, an unrefined cane sugar, is valued for its natural sweetness and nutritional benefits. However, its traditional solid block form presents several limitations:
1. Slow Dissolution—Solid panela requires manual grating or extended heating, leading to inconsistent sweetness distribution in recipes and beverages.
2. Limited Versatility—The lack of a liquid format restricts panela's use in drizzles, spreads, beverages, and ready-to-mix applications.
3. Consumer Inconvenience—Traditional preparation methods are labor-intensive, making panela less accessible compared to refined syrups.
4. Industry Gap—Existing liquid sweeteners (e.g., sugar syrups, honey, agave) lack panela's rich caramel-like flavor and micronutrient profile, leaving a demand for authentic natural alternatives.

### Technical Advancements Introduced by the Invention

This invention presents an optimized production method that transforms solid panela into a homogeneous, shelf-stable syrup, overcoming key challenges by:
Ensuring rapid dissolution without graininess, creating a smooth, even-textured syrup.
Preserving panela's natural composition while improving its usability in culinary and beverage formulations.
Integrating natural ingredients (e.g., cinnamon, coffee, citrus extracts) to enhance depth of flavor.
Expanding beverage applications, including a carbonated panela-based soda with controlled CO₂ infusion.
Using microfiltration to refine texture and eliminate particulates, ensuring a consistent final product.

### Cultural & Market Significance

This process modernizes panela consumption while maintaining its cultural authenticity. By converting panela into a ready-to-use liquid format, the invention meets consumer demand for natural sweeteners in both home and commercial food sectors, bridging tradition with modern convenience.

### SUMMARY OF THE INVENTION

The present invention provides a method and system for transforming solid panela into a homogeneous, condensed sweetener optimized for culinary and beverage applications. The process involves breaking down solid panela, combining it with water, and incorporating natural ingredients such as fruit juices and spices to create a versatile syrup.

The method ensures efficient dissolution, preserving the nutritional integrity of panela while enhancing its usability. Microfiltration eliminates impurities, and the final product can be used as a drizzle, spread, or beverage base, including carbonated soda formulation. This invention improves convenience, uniform sweetness, and versatility, addressing the limitations of traditional solid panela, making it more accessible for modern food and beverage applications.

### BRIEF DESCRIPTION OF THE PROCESS

### Production Flow Diagram

This diagram outlines the step-by-step transformation of solid panela into a condensed sweetener, optimized for industrial scalability and quality assurance. The process involves:

### Stage 1—Initial Processing System

1. Crushing Stage—Mechanically reducing panela into uniform granules to improve dissolution efficiency.
2. Mixing & Heating Process—Integrating panela, water, and natural ingredients under precisely controlled heating, ensuring optimal viscosity while preserving nutritional integrity.
3. Condensation & Thermal Reduction—Using gradual heat adjustments to prevent caramelization while refining the syrup texture.
4. Microfiltration for Purity—Implementing multi-stage filtration to remove solid particulates and improve consistency in large-scale production.
5. Final Packaging for Distribution—Ensuring airtight sealing for extended shelf life and commercialization.

### Stage 2—Industrial Processing System

Illustrates the high-volume production setup, featuring:
Automated Mixing Tanks—Regulating ingredient blending for uniform formulation consistency.
Precision Heating Chambers—Operating within 160° F.-200° F. thermal thresholds, preventing over-processing while maintaining panela's natural composition.
Multi-Stage Microfiltration Unit—Refining texture via sequential membrane filtration, removing excess particulates while preserving desired viscosity and flavor balance.
Automated Bottling Line—High-speed filling and sealing, ensuring quality control and commercial distribution readiness.

### Stage 3—Quality Assurance & Versatile Applications

Demonstrate how the condensed panela syrup is tested and applied across various food sectors:
Industrial Quality Control Measures—Standardized viscosity tests, microbial stability analysis, and taste validation before final packaging.
Expanded Culinary Applications—Featuring usage in baking, sauces, drink formulations, and specialty food products.
Carbonation Integration for Beverages—Showcasing controlled CO₂ infusion to create panela-based sodas, an innovative alternative to refined sugar drinks

1. A method for producing a condensed panela-based natural sweetener, comprising the steps of:
1. breaking a solid panela block into smaller pieces
2. combining said panela pieces with water to form a mixture
3. adding one or more flavor-enhancing natural ingredients selected from the group consisting of. natural fruit juices, natural powders, and aji.
4. heating the mixture while stirring continuously until the panela is completely dissolved and condensed to form a uniform syrup
5. cooling and packaging the condensed panela in an airtight container.

2. The method of claim 1, wherein the heating step is controlled to bring the mixture to a boiling point, thereby ensuring complete integration of the ingredients.

3. The method of claim 1, further comprises a step of microfiltration of the syrup to remove residual particulates before packaging.

4. The method of claim 1, wherein the condensed panela syrup is diluted with water and combined with carbon dioxide (CO₂) to form a sparkling beverage.

5. The method of claim 1, wherein the natural ingredients include at least one of the following: lemon juice, orange juice, pineapple juice, coffee powder, cinnamon powder, or cardamom among others.
